(19) United States
(12) Patent Application Publication
(10) Pub. No.: US 2017/0344650 A1
(43) Pub. Date: Nov. 30, 2017

(54) FILTERED CONTENT CREATION AND DELIVERY

(71) Applicant: Paradigm Social Media LLC, Parrish, FL (US)

(72) Inventors: Mark E. Reinisch, Parrish, FL (US); Rick Link, Tampa, FL (US)

(21) Appl. No.: 15/604,130

(22) Filed: May 24, 2017

Related U.S. Application Data
(60) Provisional application No. 62/341,697, filed on May 26, 2016.

(51) Int. Cl. G06F 17/30; H04L 12/58

(52) U.S. Cl. CPC G06F 17/30867; H04L 51/32; G06F 17/30315; G06F 17/30507; H04L 51/12

(57) ABSTRACT

Systems and methods enable the creation and delivery of targeted content as well as the delivery of user-customizable content that reflect the user's preferences. Users author posts associated with permissions that restrict access to the content. Users can also create filter settings that control the type of post content viewable by the user. A content provider processes content requests received from a client computing device operated by a user. Data within the content request is processed using query rules and query execution logic to return filtered content that is then formatted and transmitted to the client computing device for display on a webpage.

### CROSS REFERENCE TO RELATED APPLICATION

This application claims priority from U.S. provisional application No. 62/341,697 filed May 26, 2016, the entirety of which is incorporated herein.

### TECHNICAL FIELD AND BACKGROUND

The present invention relates generally to systems and methods for generating and transmitting filtered content over a computer network.

Traditional methods of delivering content over a computer network, particularly with regard to social media applications, either deliver the same content to every user or deliver content based on algorithms dictated by the content provider, such as transmitting content in chronological order or by using algorithms that attempt to predict a user's preferences based on past behaviors. However, such content delivery methods do not facilitate the delivery of targeted content and do not necessarily reflect the true preferences of a user.

It would be advantageous to provide systems and methods that facilitate the creation and delivery of targeted content as well as the delivery of user-customizable content that reflects the user's true preferences. It is, therefore, an object of the present invention to provide systems and methods that enable users to create targeted web-based content and to customize the delivery of web-based content over computer networks.

### SUMMARY

According to one embodiment of the invention, a method and system of delivering filtered content is provided. The method includes providing a database associated with a provider server where the database includes one or more posts comprising post data and viewer rights data associated with each of the one or more posts. The provider server receives a content control transmitted by a user computing device. The provider server also receives a column call transmitted by the user computing device and responds by transmitting column layout data to the user computing device. The column layout data includes one or more unique column identifiers that are each mapped to a query rule.

After transmitting the column layout data, the provider server receives a content request that includes content request data transmitted by the user computing device. The content request data includes a first unique column identifier, an encrypted GUID assigned to the user, a current content item count, and a page count. Subsequent content requests will include other unique column identifiers received from the provider server with the column layout data. The unique column identifier can be an integer mapped to a specific query rule.

The provider server decrypts the GUID to identify the user. The provider server also executes the query rule mapped to the first unique column identifier. The query rule processes the content control and the viewer rights data to filter the one or more posts and return only permitted posts, and the query rule returns a number of permitted posts that is determined based on the current content item count and the page count. The provider server formats the permitted posts for display in a scrollable content column and transmits the permitted posts to the user computing device.

### BRIEF DESCRIPTION OF THE DRAWINGS

Features, aspects, and advantages of the present invention are better understood when the following detailed description of the invention is read with reference to the accompanying figures, in which:

FIG. 1 is a schematic diagram of an exemplary hardware configuration according to one embodiment of the invention.

FIG. 2 is an exemplary home screen according to one embodiment of the invention.

FIG. 3 is an exemplary home screen according to one embodiment of the invention.

FIG. 4 is an exemplary home screen according to one embodiment of the invention.

FIG. 5 is an exemplary product page display screen according to one embodiment of the invention.

FIG. 6 is an exemplary email interface display screen according to one embodiment of the invention.

FIG. 7 is an exemplary networking display screen according to one embodiment of the invention.

FIGS. 8A-C are exemplary post-display screens.

FIG. 9 is an exemplary blocked content display screen according to one embodiment of the invention.

FIG. 10 is an exemplary edit blocked content display screen according to one embodiment of the invention.

FIG. 11 is an exemplary blocked keywords display screen according to one embodiment of the invention.

FIG. 12 is an exemplary flow diagram illustrating the process for setting filters.

FIG. 13 is a diagram illustrating the process for implementing posted content view rights and content controls.

### DETAILED DESCRIPTION

The present invention will now be described more fully with reference to the accompanying figures in which exemplary embodiments of the invention are shown. However, the invention may be embodied in many different forms and should not be construed as limited to the representative embodiments described below. The exemplary embodiments are provided so that this disclosure will be both thorough and complete and will fully convey the scope of the invention and enable one of ordinary skill in the art to make, use, and practice the invention.

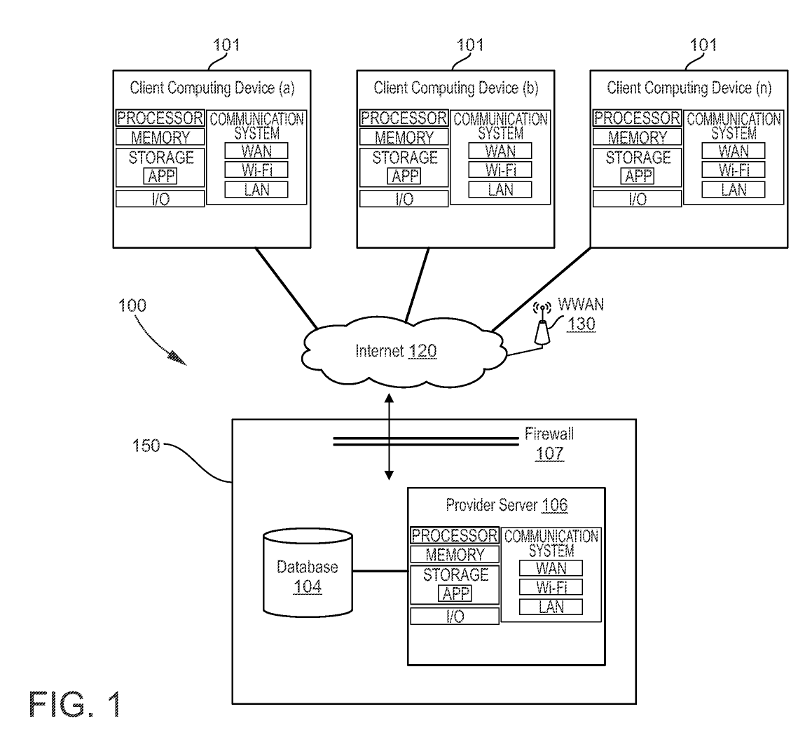

As shown in FIG. 1, a system according to one embodiment of the present invention generally includes at least one computing device 101 associated with a client and a computer system 150 associated with a content provider. The content provider computer system 150 may include a provider server 106, a database 104, and a firewall 107. The system shown in FIG. 1 is not intended to be limiting, and one of ordinary skill in the art will recognize that the systems and methods of the present invention may be implemented using other suitable hardware or software configurations. For example, the content provider computer system 150 may utilize only a single server implemented by one or more computing devices or a single computing device may implement one or more of the provider server 106, electronic document database 104, firewall 107, and/or client computing devices 101. Further, a single computing device may implement more than one step of the methods described herein; a single step may be implemented by more than one computing device; or any other logical division of steps may be used.

In one embodiment, the client computing device 101 is an electronic device that includes an integrated software application configured to operate as a user interface and to provide two-way communication with the provider's computer system 150. The electronic device can be a portable computing device, such as a cellular smartphone or tablet computer. The electronic device can include a screen and one or more buttons, among other features. The screen can be a touch screen that includes a tactile interface. The electronic device can also be a larger device, such as a laptop or desktop computer.

The client computing devices 101 and the provider server 106 may include a processor that communicates with a number of peripheral subsystems via a bus subsystem. These peripheral subsystems may include a storage subsystem, user-interface input devices, user-interface output devices, a communication system, and a network interface subsystem. By processing instructions stored on one or more storage devices, the processors may perform the steps of the present method. Any type of storage device may be used, including an optical storage device, a magnetic storage device, or a solid-state storage device.

Typically, the client computing devices 101 access the content provider computer system 150 over the Internet 120 in the normal manner—e.g., through one or more remote connections, such as a Local Area Network (“LAN”) or Wireless Wide Area Network (“WWAN”) 130 based on 802.11 standards or a data connection provided through a cellular service provider. These remote connections are merely representative of a multitude of connections that can be made to the Internet 120 for accessing the content provider computer system 150.

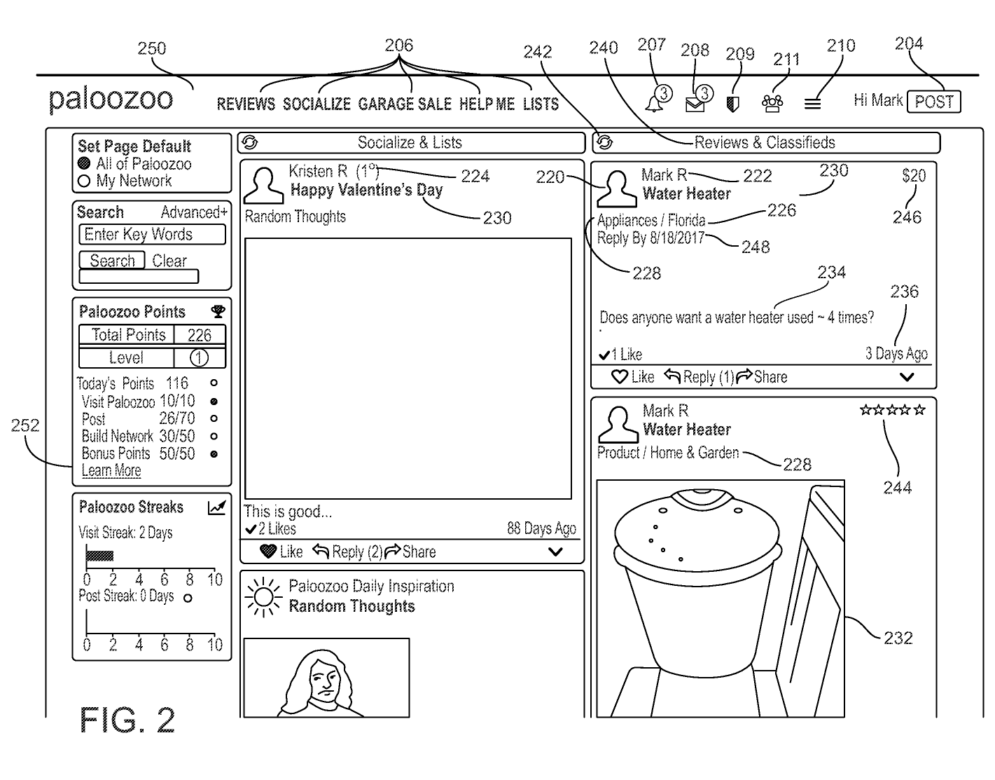

The provider server 106 and client computing devices 101 include one or more integrated software applications that provide a graphical user interface, permit communication with other electronic devices, and generally implement the steps of the methods disclosed herein. Exemplary user interface display screens are depicted in FIGS. 2-11. The user-interface screens may include features for displaying information and accepting inputs from users, such as text boxes, data fields, hyperlinks, pull down menus, check boxes, radio buttons, and the like. One of ordinary skill in the art will appreciate that the exemplary functions and user-interface display screens shown in the attached figures are not intended to be limiting, and an integrated software application may include other display screens and functions.

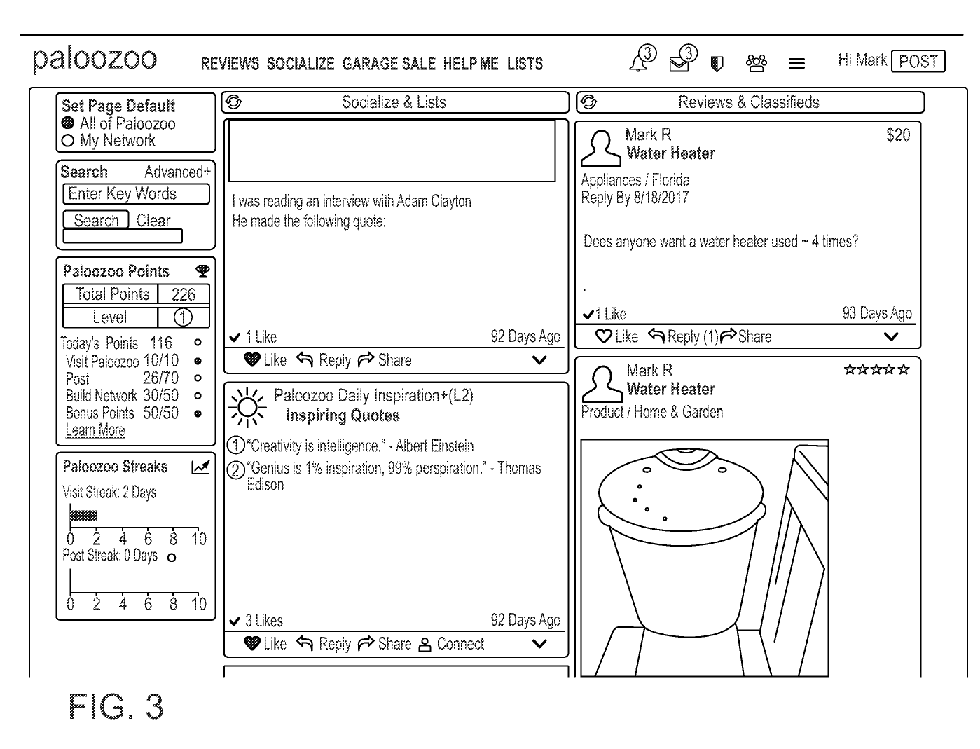

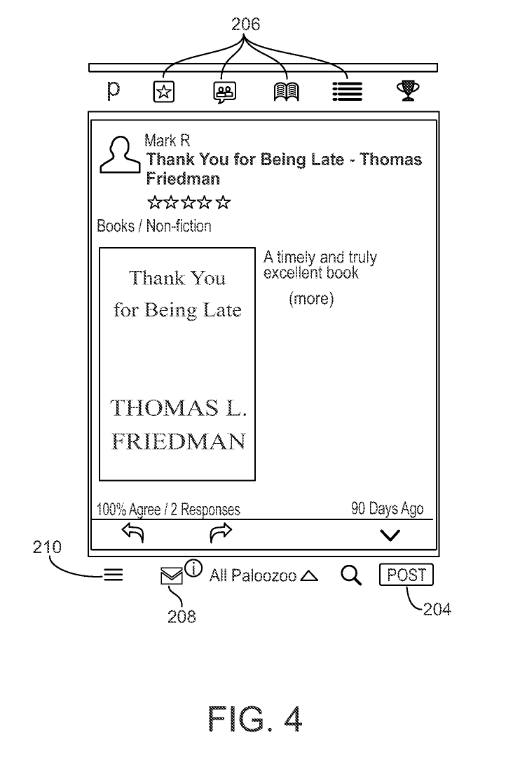

The layout and appearance of the display screens can vary depending on the software and hardware configuration of the client computing device 101, including whether the computing device is a mobile device, tablet, or personal computing device or whether the user is accessing the provider system with an Internet browser or a dedicated mobile software application. To illustrate, the exemplary home screen shown in FIGS. 2 and 3 is displayed when a user is accessing the provider system 150 with a desktop or tablet device, and the exemplary home screen of FIG. 4 is displayed when a user accesses the provider system 150 with a cellular smartphone. The home screen shown in FIGS. 2 and 3 has two scrollable content columns while the home screen of FIG. 4 for cellular smartphones has a single scrollable column to accommodate smaller device display sizes.

The scrollable content columns include content elements called “posts” authored by individual users. The posts incorporate various graphical and textual post data elements including, but not limited to: a user avatar 220 for the post author; a screenname for the post author 222; a relational indicator 224; demographic data (e.g., geographic location) 226; a post classification 228; a post title 230; a picture 232; author commentary 234; a date-time stamp 236 indicating when the post was published; and action functions that permit users to Reply to, Like, Save, or Share a post, as well as a Connect function that transmits a connect request to the post author. The Reply function permits users viewing a post to upload text or pictorial user commentary to the provider server 106 that will then be associated and displayed with the post. The Like function sets an indicator of a discrete value expressing the viewer's reaction to a post, such as liking the post, finding humor in the post, etc. The Share function allows users to send the post to another user or to “repost” the post so that it is available to the viewing user's network connections and groups, as discussed in more detail below. Finally, the Save function permits a viewing user to mark the post as saved for convenient viewing at a later time.

The scrollable content columns further include a header 240 that identifies the post classification for posts in that column. Each post is classified according to various first-, second-, or third-level product categories. First-level product categories include, for example, Reviews, Socialize, Garage Sale, Help Me, and Lists. Each first-level product category may be associated with one or more second-level product categories that are in turn associated with third-level product categories. To illustrate, the first-level product category Review is associated with second-level product categories that include Bars & Night Clubs, Books, Concerts & Shows, Hotels & Lodging, Movies, Music Albums, Products, Recipes, Restaurants, and more. The Hotels & Lodging second-level product category can further be associated with various third-level categories, such as Bed & Breakfast, Hotel, Motel, Resort, or Other.

The displayed post data can vary depending on the post classification. By way of example, posts in the Review product category include a rating indicator 244, such as a series of stars shown in FIGS. 2-3 that are filled-in according to the favorability the rating. As a further example, posts in the Review & Classified product category can include a price indicator 246 as well as a “Reply By” date 248.

With regard to the home screen shown in FIGS. 2-3, the scrolling content columns are configured to be independent of each other such that a user can navigate one column by scrolling up or down while the other columns remain static. This feature is illustrated in FIG. 3 where the left post column is scrolled down relative to FIG. 2 while the right column remains static. The posts in each scrolling content column can also be changed independent of the other columns by, for instance, selecting the Refresh 242 function in the column header to load updated posts or post data or new posts. For instance, selecting the Refresh function can display posts that were published subsequent to the previous page load or refresh as well as display updated post data for existing posts, such as additional user commentary, a change in price for items listed for sale, and updates to the number of “likes” a post has received, etc.

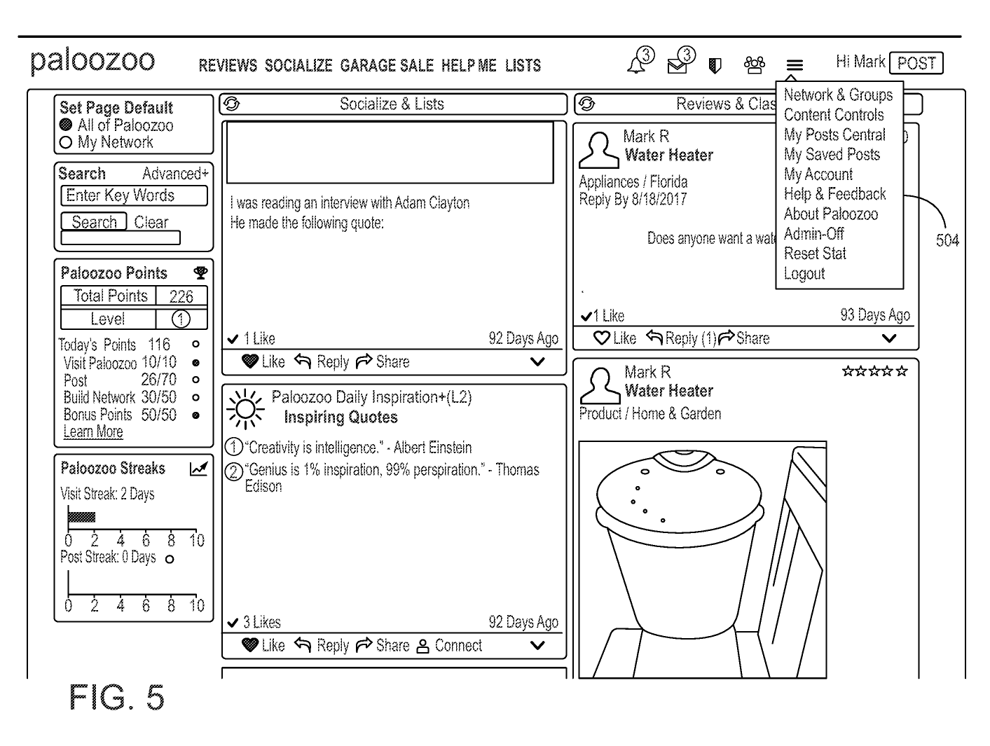

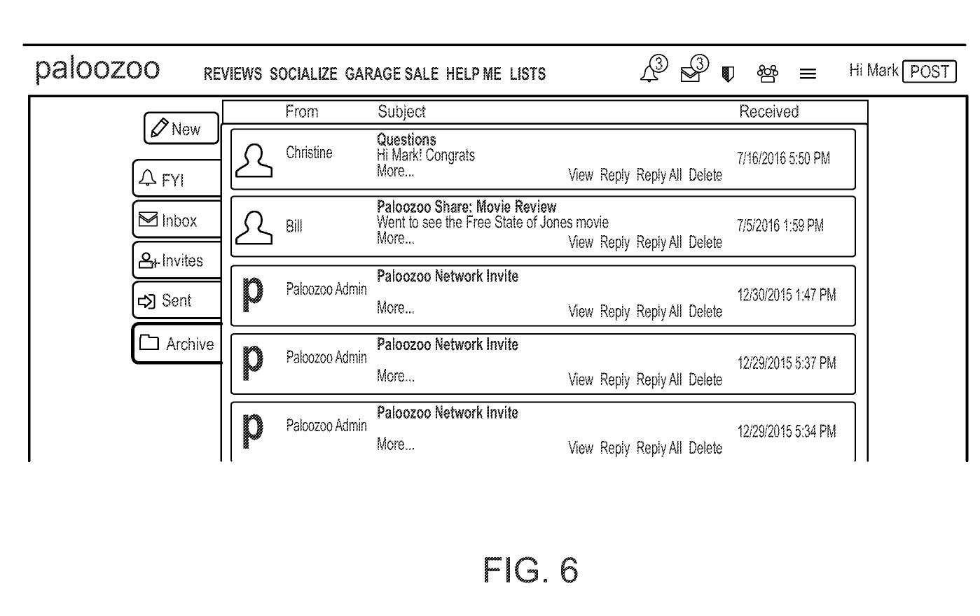

The home screen of FIGS. 2-3 further includes a navigation header 250 and a utility panel 252. The navigation header provides links and menus to accomplish various user functions, including a Post pull-down menu 204, a notifications link 207, an Email link 208, a content controls link 209, a network & groups link 211, a Settings pull-down menu 210, and links corresponding to first-level product webpages 206. Selecting one of the first-level product links (i.e., Reviews, Socialize, Garage Sale, Help Me, and Lists) will change the scrolling content column elements such that each column includes only posts with the corresponding post classification, including a scrolling content column that displays only posts saved by the user for later viewing, as illustrated in FIG. 5. Selecting the Email function of the navigation header opens the exemplary Email display screen shown in FIG. 6 that allows users to view and exchange messages with other users, among other features.

Selecting the Settings pull down menu displays the links and functions 504 shown in FIG. 5 that permit users to: manage user networks and groups (Network & Groups); set content filters (Content Controls); view posts authored by the user (My Posts Central); view posts saved by the user for later reference (My Saved Posts); display helpful information about operating the user interface or contacting the provider (Help & Feedback); edit account settings (My Account); adjust the size of pictures in the post elements (Picture Size); or log out and end a communication session with the provider server (Logout); as well as any other useful functions for a user.

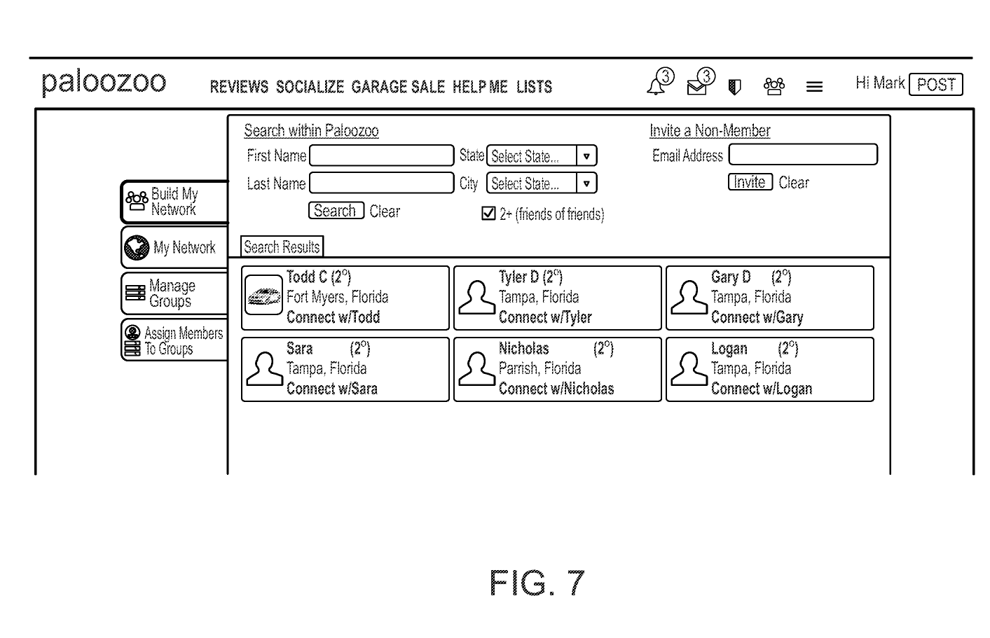

Users can connect with other users to build a network using the exemplary networking display screen of FIG. 7 that is accessed by selecting the Network & Groups link from the Settings pull-down menu. Users can search for other users and send a connect request message seeking authorization to add the recipient user to the sender's network. Users can then organize network members into one or more groups. The connection will be indicated in a relationship indicator that appears in posts authored by a network member. An exemplary relationship indicator of “(1°)” is shown in the posts under the Socialize & Lists column header of FIGS. 2-3 to indicate that the post author is a direct, first-degree connection and part of the viewing user's network. An indicator of “(2°)” (i.e., second degree) can be displayed if the post author is connected to one of the viewing user's network connections but not connected directly to the viewing user (i.e., not in the viewing user's network).

Connecting with other users and creating groups is useful for, among other things, setting permission that determine which users are permitted to view and access posts. In this manner, users can author posts that are targeted to particular groups. So, for instance, a user can organize his or her network connections into separate groups for Social Friends and Professional Affiliations. If the user authors a post with a post classification of the first-level product category “Socialize,” the author can set permissions so that the post is viewable only to those network connections in the Social Friends group.

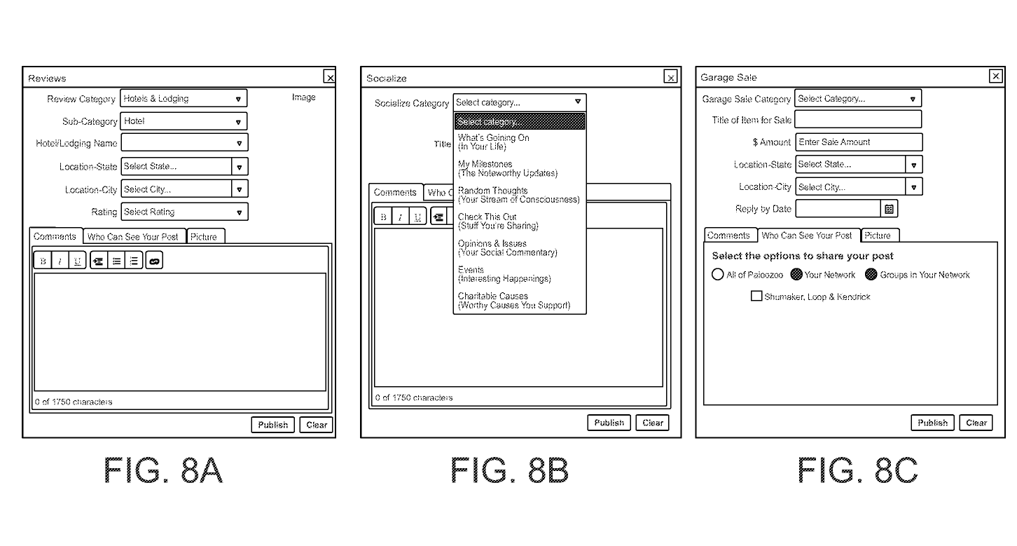

Users author a post by first selecting the Post pull-down menu from the home screen. The post pull-down menu displays options corresponding to the first-level product categories. Users select a menu option to access the exemplary post display screens shown in FIGS. 8A-8C. From the post display screen, an author enters post data, including, for example, any applicable second- and third-level product categories, a post title, a geographic location, and user commentary. A post author can additionally set permissions that determine which network connections and groups can view the post, as illustrated in FIG. 8C.

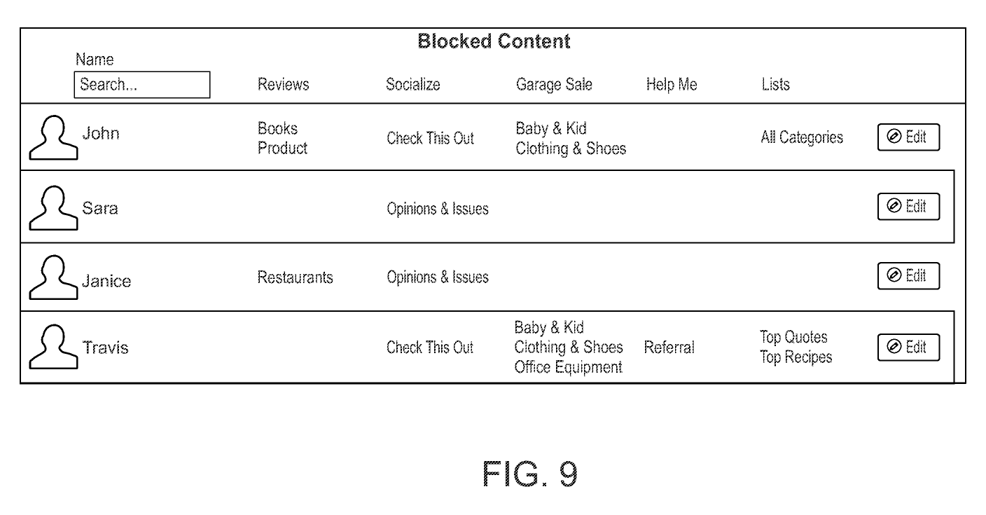

In addition to setting permissions for viewing and accessing posts, users can also set filters that determine what posts are viewable to the user. Filters are set by first selecting the Content Controls option from the Settings pull-down menu to access the blocked content display screen of FIG. 9. The blocked content display screen shows a list of the user's network connections and provides columns that identify the first- and second-level product categories for post classifications that are blocked from viewing. To illustrate with reference to FIG. 9, the user will not be able to view posts from the user “Sara” that have a first-level product category of Socialize and a second-level product category of Opinions & Issues. In this manner, users can customize the delivery of content to the client computer device 101.

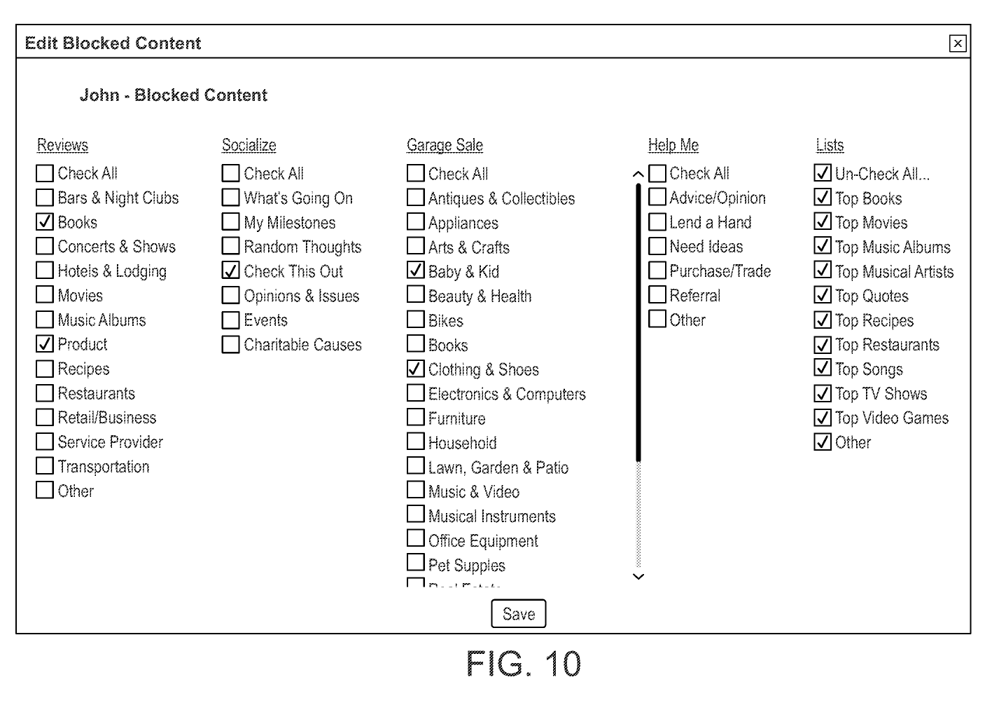

The filter settings for each network connection can be edited by selecting the Edit function to display the edit blocked content display screen of FIG. 10. From the edit blocked content display screen of FIG. 10, users select checkboxes that correspond to first- or second- level product categories and then select the Save function to store the content filters to the provider server 106. The result is that posts authored by the particular network connection will be blocked from display to the user if the post classification corresponds to the selected product categories.

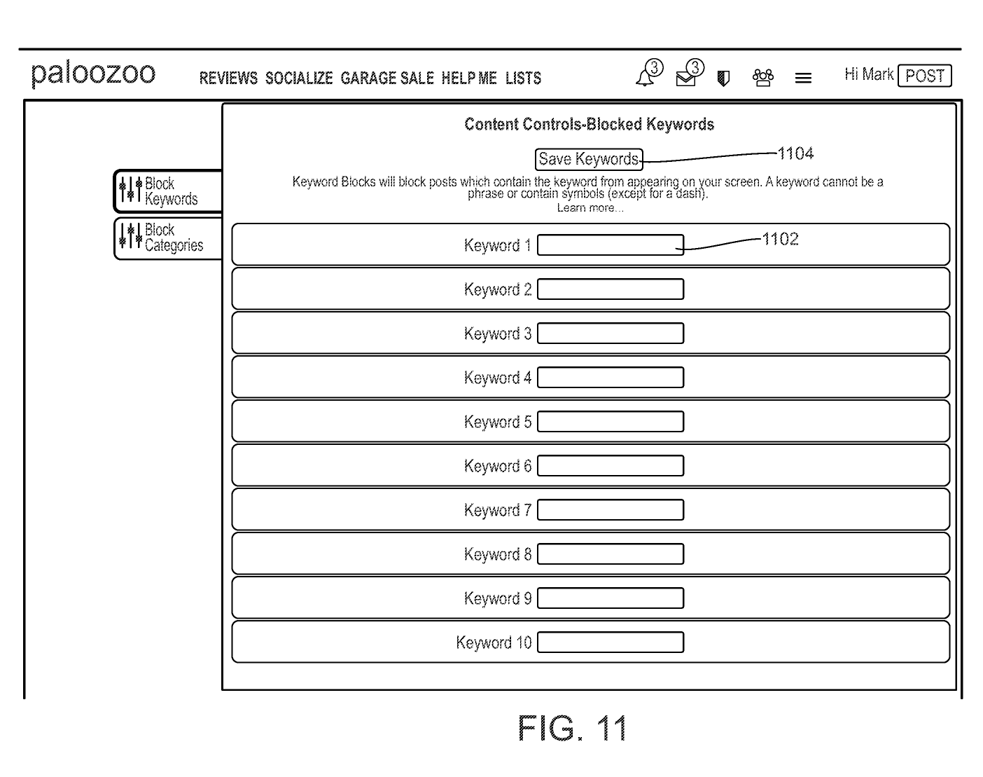

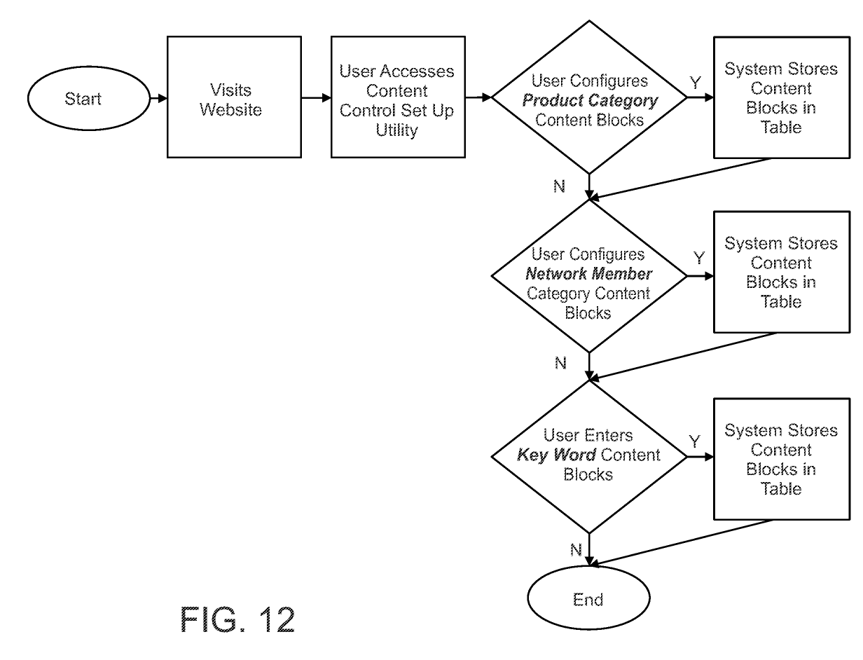

Those of ordinary skill in the art will recognize that the exemplary content filters shown in FIGS. 9 and 10 are not intended to be limiting, and other types of filers can be created. For instance, filters can be provided that permit users to block post with a particular post classification regardless of the author, or post can be blocked if they contain particular post data, such as keywords contained in the title or user commentary. A display screen that enables users to block posts containing certain keywords is depicted in FIG. 11. Users access the Blocked Keywords display screen of FIG. 11 by selecting the Blocked Keywords 1102 function from the blocked content display screen accessed by selecting the Content Controls function from the Settings pull down menu 504. Users enter keywords into the text boxes 1103 and select the Save Keywords 1104 function to block posts that contain the entered keywords. An exemplary process for setting various types of filters is illustrated in the flow chart of FIG. 12.

Users can also customize the display and delivery of content to the client computing device 101 using functions available in the utility panel of FIGS. 2-3. The utility panel can provide a Set Page Default function that permits users to display posts authored by any other user or only posts authored by the user's network connections through selection of the applicable radio button. The utility panel can also provide a Search function that allows users to display only those posts containing certain keywords. The user enters the desired keywords in a text box under the Search tab and enters the desired search parameters, such as searching for posts authored by any user, any user in the viewer's network, or by a specified user, or searching for posts within a given group.

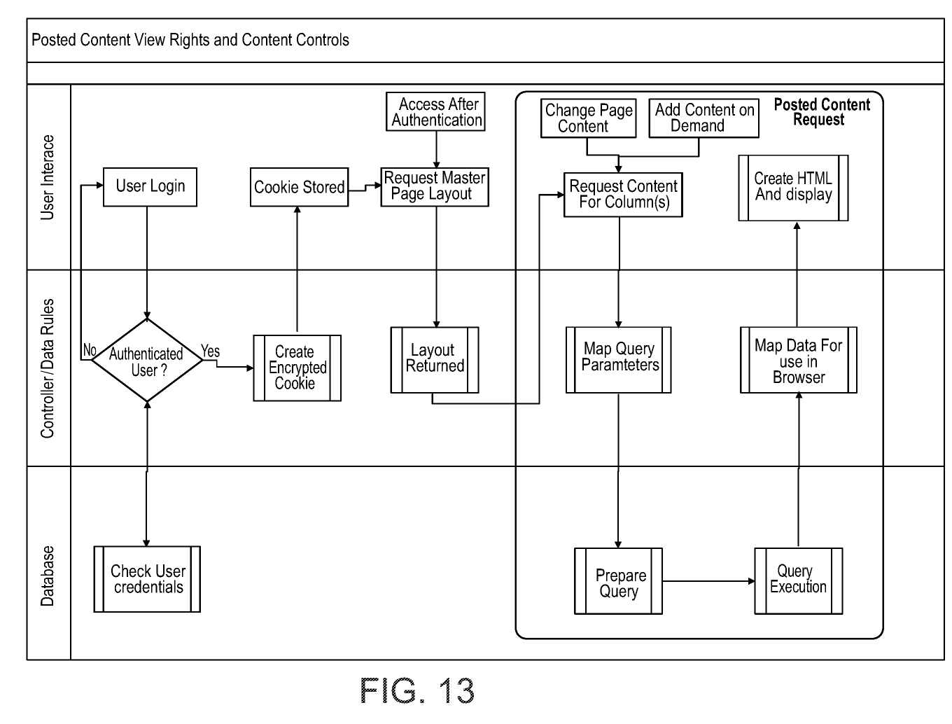

An exemplary process for retrieving posted content is shown in FIG. 13. A user operating the client computing device 101 navigates to a website associated with a content provider and logs in using authentication data, such as a username and password. If the authentication is successful, the provider server 106 responds by transmitting an encrypted cookie that is stored to the client computing device 101. The encrypted cookie is created by encrypting a global user identifier (“GUID”). The GUID is unique to a given user and is generated at the time a user account is created. In one embodiment, the GUID is a randomly generated string of thirty-six characters. The client computing device 101 can attach the encrypted cookie to subsequent communications to authenticate the communication and associate the communication with a given user.

The encrypted cookie is generated by applying a hashing algorithm to a client identification number or code. Hashing techniques apply a hashing algorithm to known data to create a one-way hash value. Any suitable hashing algorithm can be used, including, but not limited to, SHA-1 or SHA-2 algorithms. A one-way hash value is preferably a value of fixed length that is unique to the known data. In other words, if the known data is changed in any respect, the hash value will also change. The hash value, thus, acts as an encrypted fingerprint for the known data that can only be deciphered with an encryption key. On receiving a communication containing an encrypted cookie, the provider server 106 validates the encrypted cookie by using an encryption key to decrypt the cookie and then comparing the cookie to known client identifiers stored in a database on the provider server 106.

Following successful authentication, the client computing device 101 transmits a page load request to the provider server 106. The provider server 106 returns a default Master Page Layout containing master page data. The master page data incorporates elements that are common to multiple webpages in a website maintained by a provider, such as a common header or footer. The master page data can also include placeholder elements for content that is customized to each webpage, such as user posts. The mater page data is formatted as a combination of hypertext markup language (“html”), XML, Javascript, and/or cascading style sheets.

After receiving the default Master Page Layout, the client computing device 101 transmits a column call to the provider server 106, and the provider server 106 responds by transmitting to the client computing device 101 column layout data that includes: specific column layout html; unique column identifiers (“UCIDs”); a page count; or other useful page layout data. In one embodiment, the UCIDs are integer values mapped to specific query rules. The specific column layout html and page count are extracted from the column layout data, and the column layout data is added to the Master Page Layout by the client computing device 101.

After receiving the column layout data, the client computing device 101 transmits a content requests to the provider server 106 for each UCID. Each content request includes content request data, such as: an encrypted cookie; a user-agent anti-forgery token; a UCID; a current content item count (i.e., the number of posts currently loaded); a page count (i.e., the number of pages to be returned); and user-entered search parameters, such as those input through the utility panel. The current content item count is set to zero if no content has been previously loaded. The page count is a customizable parameter that represents the number of posts returned in response to a content request. The provider server 106 utilizes the current content item count and page count to determine the particular posts that should be transmitted to the client computing device 101. So, for example, if a provider server 106 has twenty posts available for transmission, the current content item count is 10, and the page count is 5, then a provider server 106 will transmit post numbers eleven through fifteen to the client computing device 101 in response to a content request (i.e., the next 5 posts after the tenth post).

The methods described herein are asynchronous in that the entire webpage does not need to be reloaded every time new data is requested from the provider server 106. In this manner, when a user scrolls through a scrolling content column or selects the Refresh function, the default Master Page Layout and the column layout data remains the same and need not be reloaded. Instead, content requests are transmitted to update the post content data. When a user selects a first-level product webpages 206 link from the navigation header 250, the master page layout data remains the same, but the client computing device 101 transmits a column call and one or more content requests to update the scrolling content column data. Some display screens, such as the exemplary email interface display screen and the networking display screen, do not use post content data, and loading these display screens does not utilize the content request message transmission but only the processing of page load and column call messages.

The encrypted cookie in the content request is decrypted by the provider server 106 and correlated to a user identifier. The user agent anti-forgery token is associated with the particular integrated software program utilized by the client computing device 101 to implement the methods described herein. The provider server 106 compares the user-agent anti-forgery token received from the client computing device 101 to known values to determine if the integrated software utilized by the client computing device 101 is a trusted source.

Content request data, including the UCID, the current content item count, page count, and user-entered search parameters, are passed to a stored procedure as part of retrieving content from a provider database 104. In one exemplary embodiment, when a stored procedure is executed, a Structured Query Language (“SQL”) script, or query rule, is retrieved. The query rule is mapped to the UCID for each content request message. Content in the form of user posts is returned after the provider server 106 executes the query rule that is mapped to the UCID contained in the content request. The query rule is executed, and content data is returned per the query execution logic.

Query rules are processed using query execution logic that implements authorization view permissions set by content post authors, filters set by users viewing a post, and search parameters set by viewing users. Query rules utilize a variety of data to receive post content, including: pre-populated post-classification data that correlates to the UCID; a GUID that replaces a user ID token value in the SQL script/query rule; a current content item count that replaces an offset parameter in the SQL script/query rule; a page count that replaces a token limit parameter in the SQL script/query rule; and additional query code created and added to the SQL script/query rule to implement any user-entered search parameters. The additional query code replaces a search token in the SQL script/query rule, which is removed if no user-entered search parameters are provided.

The query logic can be better understood with reference to the following simplified example utilizing a series of content rules. First, a first content rule is applied to identify and exclude content posts where the post author requires viewing uses to be among the author's network connections, and the viewing user is not, in fact, a member of the post author's network. A second content rule is applied to exclude posts that require a viewing user to be a member of the post author's network groups where the requesting user is not a member of the post author's groups. Additional content rules can include excluding: (a) post content blocked by the user (rule No. 3); (b) posts by authors that are filtered by the user (rule No. 4); (c) post content from a post author who is a member of the user's network but has a network status of “unfollow” (rule No. 5); (d) post content that correlates to a post-classification and post author filtered by the viewing user (rule No. 6); (e) post content that does not meet user-entered search parameters (rule No. 7); (f) expired post content, as determined by, for instance, the Reply By post data and the current time and date known to the provider server 106 (rule No. 8); and (g) content that should not be returned based on the current content item count and page count (rule No. 9).

Those of ordinary skill in the art will appreciate that these examples of content rules are not intended to be limiting, and any suitable set of content rules can be applied. Additionally, the above-exemplary content rules need not be applied to every content request. For instance, content rule Nos. 1-6 are not applied to retrieve saved post content, and content rule Nos. 1-6 and 8 are not applied to post content authored by the viewing/requesting user. In some embodiments, the query execution logic can be determined by a query optimizer at run time.

The post content returned by query rule execution is formatted by the provider server 106 for use by a jQuery plugin running on the client computing device 101 and packaged as JSONP data before being transmitted to the client computing device 101. The client computing device 101 iterates through the JSONP data, transforms it to html, and inserts the JSONP data into the portion of the column layout associated with the UCID that was included in the corresponding content request message.

The system 100 can be implemented with the ASP.NET MVC application framework and the MySQL database storage engine, or any other suitable web application framework and relational database management system. Web user interfaces can be implemented with html, cascading style sheets, and jQuery to control and manage website interface behavior. Data requests transmitted from the client computing device 101 to the provider server 106 are authenticated through AJAX requests using JSON/JSONP data formats or standard content requests.

Although the foregoing description provides embodiments of the invention by way of example, it is envisioned that other embodiments may perform similar functions and/or achieve similar results. Any and all such equivalent embodiments and examples are within the scope of the present invention.

What is claimed is:

1. A computer-implemented method for filtered content delivery comprising the steps of:
(a) providing a client computing device associated with a user and a provider computing device having a data storage device, wherein the data storage device includes one or more posts comprising post data and viewer rights data associated with each of the one or more posts;
(b) receiving, by a provider computing device, a content control transmitted by the client computing device;
(c) receiving, by the provider computing device, a column call transmitted by the client computing device, and responding to the column call by transmitting column layout data from the provider computing device to the client computing device, wherein the column layout data comprises one or more unique column identifiers that are each mapped to a query rule;
(d) receiving, by the provider computing device, a content request comprising content request data transmitted by the client computing device, wherein the content request data comprises a first unique column identifier, an encrypted GUID assigned to the user, a current content item count, and a page count;
(e) decrypting, by the provider computing device, the encrypted GUID and identifying the user assigned to the GUID;
(f) executing, by the provider computing device, the query rule mapped to the first unique column identifier, wherein (i) the query rule processes the content control and the viewer rights data to filter the one or more posts and return only permitted posts, and (ii) the query rule returns a number of permitted posts that is determined based on the current content item count and the page count;
(g) formatting, by the provider computing device, the permitted posts for display in a scrollable content column; and
(h) transmitting, by the provider computing device, the permitted posts to the client computing device.

2. The computer-implemented method of claim 1, wherein:
(a) the post data comprises author data that identifies a post author;
(b) the viewer rights data restricts display of the one or more posts to network members assigned to the post author by the provider computing device where each network member has a dedicated GUID; and wherein
(c) processing the viewer rights data comprises the operation of filtering the one or more posts according to whether the user is a network member as determined by comparing the dedicated GUID for each network member to the decrypted GUID received from the client computing device.

3. The computer-implemented method of claim 1, wherein:
(a) the post data comprises author data that identifies a post author;
(b) the viewer permission data restricts display of the one or more posts to a network group assigned to the post author by the provider computing device where the network group is comprised of network members with a dedicated GUID; and wherein
(c) processing the viewer rights data comprises the operation of filtering the one or more posts according to whether the user is part of a network group by comparing the dedicated GUID for each network member within the network group to the decrypted GUID received from the client computing device.

4. The computer-implemented method of claim 1, wherein:
(a) the post data comprises a product category;
(b) the content control is a category block specifying a first product category; and
(c) processing the content control comprises the operation of filtering the one or more posts according to the first product category so that the permitted posts do not include posts having post data that matches the first product category.

5. The computer-implemented method of claim 1, wherein:
(a) the post data comprises a product category and author data that identifies a post author;
(b) the content control is an author-category block specifying a first author and a first product category; and
(c) processing the author-category block comprises the operation of filtering the one or more posts according to the author data and the first product category so that the permitted posts do not include posts having post data that matches the first author and the first product category.

6. The computer-implemented method of claim 1, wherein:
(a) the post data comprises text data;
(b) the content control is a keyword block specifying a keyword; and
(c) processing the content control comprises the operation of filtering the one or more posts according to the text data so that the permitted posts do not include posts having text data that matches the keyword.

7. The computer-implemented method of claim 1 further comprising the steps of:
(a) receiving, by the client computing device, the permitted posts;
(b) displaying, by the client computing device, the permitted posts on a webpage with at least one asynchronous scrollable content column.

8. The computer-implemented method of claim 1, wherein:
(a) the content request comprises a user-entered search parameter; and
(b) executing the query rule further comprises the operation of filtering the one or more posts according to the user-entered search parameter to return permitted posts that match the user-entered search parameter.

9. The computer-implemented method of claim 1, wherein:
(a) the post data comprises a reply-by date; and
(b) executing the query rule further comprises the operation of filtering the one or more posts according to the reply-by date so that the permitted posts do not include posts with a reply-by date that is earlier than a current date maintained by the provider computing device.

10. The computer-implemented method of claim 1 further comprising the steps of:
(a) receiving, by the client computing device, a Mater Page Layout transmitted by the provider computing device;
(b) extracting, by the client computing device, specific column layout html and the page count from the column layout data;
(c) receiving, by the client computing device, the permitted posts;
(d) generating, by the client computing device, a webpage with at least one asynchronous scrollable content column by incorporating the column layout html, the page count, and the permitted posts into the Master Page Layout.

11. A system for filtering content delivery comprising:
a first processor associated with a provider;
a second processor associated with a user;
a data storage device including a non-transitory computer-readable medium having computer readable code for instructing the processors, and when executed by the processors, the processors perform operations comprising:
(a) storing, by the first processor, one or more posts comprising post data and viewer rights data associated with each of the one or more posts;
(b) receiving, by the first processor, at least one content control transmitted by the second processor;
(c) receiving, by the first processor, a column call transmitted by the second processor, and responding to the column call by transmitting column layout data from the first processor to the second processor, wherein the column layout data comprises one or more unique column identifiers that are each mapped to a query rule;
(d) receiving, by the first processor, a content request comprising content request data transmitted by the second processor, wherein the content request data comprises a first unique column identifier, an encrypted GUID assigned to the user, a current content item count, and a page count;
(e) decrypting, by the first processor, the encrypted GUID and identifying the user assigned to the GUID;
(f) executing by the first processor, the query rule mapped to the first unique column identifier, wherein (i) the query rule processes the content control and the viewer rights data to filter the one or more posts and return only permitted posts, and (ii) the query rule returns a number of permitted posts that is determined based on the current content item count and the page count;
(g) formatting, by the first processor, the permitted posts for display in a scrollable content column; and
(h) transmitting, by the first processor, the permitted posts to the client computing device.

12. The system of claim 11, wherein:
(a) the post data comprises author data that identifies a post author;
(b) the viewer rights data restricts display of the one or more posts to network members assigned to the post author by the first processor where each network member has a dedicated GUID; and wherein
(c) processing the viewer rights data comprises the operation of filtering the one or more posts according to whether the user is a network member as determined by comparing the dedicated GUID for each network member to the decrypted GUID received from the client computing device.

13. The system of claim 11, wherein:
(a) the post data comprises author data that identifies a post author;
(b) the viewer permission data restricts display of the one or more posts to a network group assigned to the post author by the first processor where the network group is comprised of network members with a dedicated GUID; and wherein
(c) processing the viewer rights data comprises the operation of filtering the one or more posts according to whether the user is part of a network group by comparing the dedicated GUID for each network member within the network group to the decrypted GUID received from the client computing device.

14. The system of claim 11, wherein:
(a) the post data comprises a product category;
(b) the content control is a category block specifying a first product category; and
(c) processing the content control comprises the operation of filtering the one or more posts according to the first product category so that the permitted posts do not include posts having post data that matches the first product category.

15. The system of claim 11, wherein:
(a) the post data comprises a product category and author data that identifies a post author;
(b) the content control is an author-category block specifying a first author and a first product category; and
(c) processing the author-category block comprises the operation of filtering the one or more posts according to the author data and the first product category so that the permitted posts do not include posts having post data that matches the first author and the first product category.

16. The system of claim 11, wherein:
(a) the post data comprises text data;
(b) the content control is a keyword block specifying a keyword; and
(c) processing the content control comprises the operation of filtering the one or more posts according to the text data so that the permitted posts do not include posts having post data that matches the keyword.

17. The system of claim 11, wherein:
(a) receiving, by the second processor, the permitted posts;
(b) displaying, by the second processor, the permitted posts on a webpage with at least one asynchronous scrollable content column.

18. The system of claim 11, wherein:
(a) the content request comprises a user-entered search parameter; and
(b) executing the query rule further comprises the operation of filtering the one or more posts according to the user-entered search parameter to return permitted posts that match the user-entered search parameter.

19. The system of claim 11, wherein:
(a) the post data comprises a reply-by date; and
(b) executing the query rule further comprises the operation of filtering the one or more posts according to the reply-by date so that the permitted posts do not include posts with a reply-by date that is earlier than a current date maintained by the first processor.

20. The system of claim 11, wherein:
(a) receiving, by the second processor, a Mater Page Layout transmitted by the first processor;
(b) extracting, by the second processor, specific column layout html and the page count from the column layout data;
(c) receiving, by the second processor, the permitted posts;
(d) generating, by the second processor, a webpage with at least one asynchronous content column by incorporating the column layout html, the page count, and the permitted posts into the Master Page Layout.
